(19) United States
(12) Patent Application Publication
(10) Pub. No.: US 2007/0092772 A1
(43) Pub. Date: Apr. 26, 2007

(54) Fuel cell system and polymer electrolyte fuel cell system

(76) Inventors: Katsunori Nishimura, Hitachiota (JP); Jinichi Imahashi, Hitachi (JP); Masahiro Komachiya, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/528,512

(22) Filed: Sep. 28, 2006

(30) Foreign Application Priority Data
Oct. 20, 2005 (JP) 2005-305751

(51) Int. Cl. H01M 8/04; H01M 8/10

(52) U.S. Cl. 429/23; 429/30; 429/34

(57) ABSTRACT

A fuel cell system comprises an electrolyte membrane having an ion conductivity, a pair of electrodes contacting with the electrolyte membrane, and a separator having at least a passage for an oxidant gas, and a device for setting a cell voltage to substantially zero at the time of an stop operation of the fuel cell by setting a flow rate of the oxidant gas in the passage to substantially zero in a state of taking out a current from the cell.

### CLAIM OF PRIORITY

The present application claims priority from Japanese application serial no. 2005-305751, filed on Oct. 20, 2005, the content of which is hereby incorporated by reference into this application.

### FIELD OF THE INVENTION

The present invention relates to a polymer electrolyte fuel cell system, particularly relates to a technique for stopping operation of the same.

### BACKGROUND OF THE INVENTION

A polymer electrolyte fuel cell has advantages where the output is high, the lifetime is long, the time-deterioration caused by repetition of start and stop is little, the operation temperature is low (about 70 to 80° C.), the start and stop operation are easy. For the reason, it is expected that the polymer electrolyte fuel cell is widely applied to an electric vehicle power feed, and a commercial and residential dispersed power supply.

Among those applications, the dispersed power supply (for example, a cogeneration system) on which the polymer electrolyte fuel cell is mounted is capable of taking electricity from the polymer electrolyte fuel cell simultaneously with recovering heat produced from the cell as warm water at the time of generating electricity. As a result, the system is intended to effectively use the energy.

The dispersed power supply of the above-mentioned type is required to have a lifetime of 50,000 hours or longer as the duration of use, and an improvement in a membrane electrode assembly, a cell configuration, and electricity generation conditions are being advanced. Also, in the entire electricity generation system in which a fuel cell is mounted, users desire to suppress an output reduction and electricity generation efficiency reduction caused by repetition of start and stop operation at minimum. In particular, it is required to provide the electricity generation stopping method for preventing the output voltage from dropping at the restart of the system after stopping. In the related prior arts, JP-A Hei 5-251102 and JP-A Hei 10-144334 disclose that an inert gas purge is used for stopping a generation operation in a phosphate fuel cell system. This manner is also applicable to the polymer electrolyte fuel cell.

However, in order to save a space of the electricity generation system and downsize the facility, a stopping method using no inactive gas is desired. Incidentally the stopping method using the inert gas purge is improper for the dispersed power supply system intended for home use.

For the reason, a stopping method using no inert gas has been studied in the polymer electrolyte fuel cell system. In order for the non-inert gas stopping method to be realized, an output reduction caused by repetition of start and stop must be prevented in the polymer electrolyte fuel cell. During stop of the fuel cell system, a fuel gas and an oxide gas already taken in the cell may remain in the cell as-is. Therefore a local cell is produced in a plane of the membrane electrode assembly, and platinum catalyst particles in the electrode may be agglutinated. This leads to the possibility of an output voltage drop of the power supply (JP-A Hei 5-251102). Also, the following problem is indicated by the 11th fuel cell symposium lecture text, pp. 215 to 218. That is, if the oxygen remains in the cell, hydrogen, which has penetrated the polymer electrolyte membrane, reacts with oxygen on a cathode, a resultant hydrogen peroxide aids a decomposition reaction of the membrane.

In order to suppress the cell deterioration reaction, one solving means is to remove a fuel gas (anode gas). As one example, at the time of stopping the cell, there is a method of allowing the fuel gas to react with an oxide gas by making a short circuit outside the cell through a short-cut controller, in a state where the feed of the fuel gas stops and a valve at the fuel gas outlet is closed (JP-B Hei 7-93147).

As another method, there is a method of consuming oxygen of a cathode to stop the polymer electrolyte fuel cell (U.S. Pat. No. 6,068,942, and JP-A 2002-93448).

As described above, in the polymer electrolyte fuel cell, in order for purge using the inert gas at stop of the fuel cell to be omitted, it is required for a stopping operation method to be capable of preventing the output from being deteriorated due to the repetition of the start and stop operation.

### SUMMARY OF THE INVENTION

The present invention has been made in view of the above circumstances, and the present invention is to provide a fuel cell system capable of stopping a fuel cell without deterioration of the output due to the repetition of start and stop operation of a fuel cell.

The present invention is configured as follows.

A fuel cell system comprising:
an electrolyte membrane having an ion conductivity,
a pair of electrodes contacting with the electrolyte membrane, and
a separator having at least a passage for an oxidant gas,
a device for setting a cell voltage to substantially zero at the time of an stop operation of the fuel cell by setting a flow rate of the oxidant gas in the passage to substantially zero in a state of taking out a current from the cell.

In addition, a polymer electrolyte fuel cell-electricity generation system, comprising:
an inverter or converter connected to the fuel cell via a cable,
a short-cut controller for forming a short-cut, and
a changeover switch provided on the way of the cable to select a connection of the inverter or converter and the fuel cell, or a connection of the short-circuit and the fuel cell,
wherein the short-cut controller is configured to control the cell voltage to be substantially zero by making a current flow in the fuel cell for a short period of time in a state where a flow rate of an oxidant gas in a passage of a separator of the fuel cell is set to substantially zero.

According to the present invention, the inert gas purge facility can be omitted by the stopping operation mode of the fuel cell system.

### BRIEF DESCRIPTION OF THE DRAWINGS

FIG. 1 is a block diagram showing the configuration of a polymer electrolyte fuel cell system according to the present invention;

FIG. 2 is a conceptual view showing a stop operation process according to an embodiment of the present invention; and

FIG. 3 is a conceptual view of the stop operation process according to another embodiment of the present invention.

### DETAILED DESCRIPTION OF THE PREFERRED EMBODIMENTS

The fuel cell for implementing the present invention comprises a separator and a membrane electrode assembly held with the separator as a basic cell unit. The separator has a channel for circulating any one of a fuel gas and an oxidant gas. At the time of generating electricity, oxidation reaction of hydrogen is done on one side (anode) of. the membrane electrode assembly, and reducing reaction to oxygen using hydrogen ions, which have been produced by the anode and penetrated an electrolyte membrane, is done on the other surface (cathode). When executing the stop operation of the fuel cell according to this embodiment, a flow of the oxidant gas in the channel of the separator is come to rest in a state where a current is taken out of the fuel cell, thereby the cell voltage substantially becomes zero. When the flow of the oxidant gas is come to rest, water produced after reducing oxygen is coated on a cathode catalyst surface by consumption of a small amount of electricity, thereby being capable of preventing the cathode from coming in contact with oxygen.

The dissolution of oxygen in water being coated on the cathode catalyst surface is extremely small (for example, 0.018 cm ³/cm³ at 80° C. in Tokyo Observatory Science Chronologic Table), and a reducing reaction to oxygen is prevented. As a result, the cathode potential is rapidly decreased, and the cathode potential becomes substantially identical with the anode potential by an electricity generation corresponding to a slight quantity of electricity. That is, the cell potential becomes zero. It has been found from various experiments that a period of time required until the cathode potential shifts to the above state is instant and 1/10 seconds order even with a low current concentration corresponding to 0.2 A/cm².

According to the above method, at the time of stop operation in the fuel system, most oxygen is not substantially consumed in the electricity generation, and the cell voltage is not returned to an open circuit voltage even if oxygen remains in the vicinity of the cathode. This is because the cathode catalyst surface is coated with a thin film of the water that has been produced due to reduction to a slight quantity of oxygen, and the reduction to oxygen on the cathode catalyst surface is prevented. As a result, hydrogen gas or hydrogen ion, which has penetrated from the anode to the cathode, hardly reacts with oxygen on the cathode surface, thereby making it difficult to produce hydrogen peroxide. Since hydrogen peroxide deteriorates the strength of the electrolyte membrane, the stopping method according to the present invention is effective in the prevention of the cell voltage from being decreased.

Hereinafter, a description will be given in more detail of a configuration that implements a method of stopping a fuel cell according to this embodiment. The fuel cell to be applied to this embodiment is a polymer electrolyte fuel cell having a solid polymer electrolyte membrane that separates the fuel gas (anode gas) and the oxidant gas (cathode gas) from each other, which includes an inverter or a converter which is connected to the cell, and feeding pipes and discharge pipes for the fuel gas and the oxidant gas in the fuel cell.

A hydrogen gas reservoir (tank), and a hydrogen processor using water electrolysis, or a hydrogen producing device that reforms town gas or kerosene to produce hydrogen, are located upstream from the fuel gas feeding pipe with respect to the fuel cell; and the hydrogen gas reservoir is connected to the fuel gas feeding pipe. In general, a flow rate controller such as a gas feeding controller and a switching valve is disposed on the way of the fuel feeding pipe for connecting the hydrogen feeding source (hydrogen gas reservoir) and the fuel cell.

On the other hand, an air compressor, a blower, or a tank that is filled with a gas (for example oxygen) is disposed upstream from the oxidant gas feeding pipe so that air can be fed to the fuel cell through the pipe. The gas to be fed can be air or pure oxygen. In general, as described above, the flow rate controller although is frequently disposed on the feeding pipe for connecting the hydrogen feeding source and the fuel cell, it is not essential in order to implement the present invention. That is, it is possible to stop a flow of air in the passage of the separator in the fuel cell according to another method. For example, there is a method of turning off a power supply of the blower, or a method of preventing the supplementary oxidant gas to cell by the gas circulation using bypass valves. From the above viewpoint, the present invention is characterized in that the flow of the oxidant gas in the cell comes to rest, and this operation is conducted by an entirely different concept from the operation of merely stopping the feed of the oxidant gas.

It is desirable that a closing mechanism (flow rate controller, switching valve) for sealing the gas within the cell to prevent the electrolyte membrane from being dried is disposed at the outlet of the discharge pipe of the fuel gas or the oxidant gas. However, the mechanism is not essential in the implementation of the present invention.

Also, it is possible that the discharge pipe is connected on the way of the feeding pipe in the form of a loop, and a pump for circulating the gas is disposed on the looped pipe. In the case of the above configuration, at the time of stopping the fuel cell according to this embodiment, it is necessary that the circulation pump, that is disposed on the looped pipe of the oxidant gas, is stopped, and the oxidant gas in the separator within the cell comes to rest. As another method, it is possible that the valve, which is disposed on the pipe, is closed so that the flow of the oxidant gas comes to rest. A current flowing in the cell under stop operation of the cell can be supplied to the converter or the inverter which is connected to the fuel cell. Alternatively, it is possible to use a short-circuit such as a heater which is connected through a changeover switch.

In order that the oxidant gas comes to rest, it is necessary to operate the stop of the blower or the circulation pump. Also, it is necessary to conduct the electric control in order to remove the current from the fuel cell to the converter. In order to conduct the operation control, it is desirable to provide a control circuit into which a control logic is incorporated. This configuration makes it possible to conduct the automatic operation of the electricity generation system.

Subsequently, a description will be given in more detail of a method and procedure of stopping the fuel cell according to this embodiment. The fuel cell is in an open circuit state or an electricity generation state before the stop operation. When the fuel cell is in the open circuit state, the electricity generation starts after the feed of the fuel gas and the oxidant gas to the fuel cell. The state in which the cell generates electricity as described above is an initial state in the stopping operation of the present invention.

A first stage of the stop is to stop the flow of the oxidant gas that circulates in the separator of the fuel cell. This operation is a method of stopping the blower or the circulation pump. Also, it is possible to drive the gas feeding controller that is disposed on the oxidant gas feeding pipe to stop the feeding of the oxidant gas.

In order to implement the stopping method according to the present invention, it is necessary that the air flow is substantially zero in the cell (in particular, the surface of the membrane electrode assembly). The “air flow is substantially zero” includes a case of a slight flow of air caused by the natural convection between the external and the cell stack as well as a case in which the air flow becomes rigidly zero. Even in the slight flow of air, since the air flow is extremely small, the evaporation of water produced at the cathode surface is prevented, thereby making it possible to realize the present invention. Also, when the air flowing in the cell stack is a humidified air whose temperature is lower than the cell stack temperature by about 5 °C., it is desirable to control the flow quantity to a slight quantity of flow of 0.1 cc/min or lower per a unit area of the membrane electrode assembly. This is because even if an extremely small quantity of air flow exists within the cell (corresponding to “the air flow is substantially zero”), the quantity of water that can be evaporated at the cathode surface is suppressed so as to prevent a contact of the cathode with oxygen until the evaporation pressure of the humidified air reaches a saturated evaporation pressure. When the above dew-point difference is further enlarged, it is desirable to further reduce the flow rate. In this way, it is possible to make the air flow in the cell (in particular, the surface of the membrane electrode assembly) substantially zero, thereby preventing water produced at the cathode catalyst surface from being evaporated, and avoiding the contact of the cathode with oxygen.

The electricity generation is continued until the cell voltage becomes substantially zero in a state where the flow of the oxidant gas comes to rest. This period of time depends on the current concentration, and is normally instant of 1/10 order when the current concentration is equal to or higher than 0.1 A/cm². The larger the current concentration, the shorter a period of time until the cell voltage becomes substantially zero, and the catalyst of the cathode is not sufficiently protected when the cell voltage becomes zero before water is produced. Therefore, it is preferable that the current is 1.5 A or lower. This is because when the current is larger than this value, the voltage drop due to the polarization of the cell is remarkable, and the water cannot be produced on the cathode. Also, there is a limit of the feeding performance of the fuel gas in the cogeneration /electricity generation system using a reformed gas such as a town gas.

Therefore, the electricity generateable current should be confined to a range where the fuel utilization of the fuel gas is not excessive (for example, a range of the consumption of 70 to 90% with respect to the fed quantity of hydrogen). When the current is very excessive, the anode potential increases, and the oxidation of the anode catalyst and the conductive carbon is advanced, thereby inducing the deterioration of the anode catalyst. Therefore, it is general that only a current of about 1.5 to 2 times as large as the rated current is permitted to flow, and it is realistic to set the maximum permissible current to about 0.5 A/cm² or less. However, in the system that is capable of increasing/decreasing the feed quantity of hydrogen, since it is possible to allow a current of about 1 A or lower to flow as described above, the maximum permissible current should be set according to the quantity of available hydrogen.

When the cell voltage becomes zero, it is impossible to remove a current from the fuel cell per se, and the electricity generation automatically stops without conducting any operation. In other words, when the cell voltage becomes substantially zero, onlyvery small current flows. As a result, the above completion of the electricity generation may be allowed even if the cell voltage does not become strictly zero. Desirably, the completion of the electricity generation can be confirmed by confirming that the cell voltage is equal to or lower than 50 mV. Also, in the case of a cell stack that is made up of plural cells, since the voltages of the respective cells are not normally largely different from each other, the electricity generation is naturally completed at the time where the average cell voltage becomes substantially zero. In the case where the above operation is conducted while the fuel gas is circulated, additional operation is not particularly required because the anode potential is low.

On the contrary, in the case where the flow rate of the fuel gas is decreased or stopped during the stop process of the fuel cell, it is important that the cathode potential reaches the above potential until the anode potential reaches a regular upper limit cell potential. The regular upper limit cell potential is defined as a potential by which the anode catalyst is oxidized and deteriorated. For example, in the case where a carbon-based electrically conductive material is employed as platinum catalyst, the regular upper limit cell potential should not be higher than a potential by which the oxide coating is formed on platinum (about 0.6 to 0.7 V from the standard hydrogen electrode potential reference) in order to avoid the oxidative decomposition of the electrically conductive material. When the above higher potential is held, the electrically conductive material is oxidized, and electron conductivity between the particles of the platinum catalyst is lowered. As a result, the anode catalyst action is deteriorated. In the case where an assisting catalyst such as Ru is employed as a CO catalyst resistance, it is desirable that the anode potential at the time of the fuel cell stop is set to a potential or lower at which the catalyst is not solved.

Because the fuel cell cannot make a current flow when the cell potential is zero, the anode potential does not exceed the regular upper limit cell potential when the cathode potential reaches the regular upper limit cell potential during stop first. In this way, it is possible to prevent the anode catalyst from being exposed to the potential that leads to the oxidation deterioration. The above method is effective so far as there are no circumstances in which the fuel cells are connected in series or in parallel, a current is allowed to enforcedly flow in one cell by another cell, and one cell potential is remarkably reversed.

After the cell voltage becomes zero, the fuel gas feeding controller is so controlled as to stop the feeding of hydrogen to the cell. If necessary, purge using the inert gas or gas replacement using air may be conducted. In this way, since hydrogen is perfectly removed from the fuel cell, this embodiment is particularly effective in the quality maintenance in the long-term storage before product shipment, and the prevention of hydrogen leakage during transport. Hydrogen may be left as it is in the stop operation during the normal drive.

In the final step of the stop operation, the discharge pipes of the fuel gas and the oxidant gas are closed by closing the valves, so that the fuel cell is isolated from the outer air. As the occasion demands, a valve of the pipe at the gas feeding side is closed. This is because when the outer air circulates in the fuel cell, there is a fear that the cell voltage is decreased by dry or contamination of the electrolyte membrane. In the case where the fuel cell is restarted, the electricity generation is started after the valves are opened to sufficiently feed the fuel gas and the oxidant gas.

As described above, the present invention characterized in that not the feeding of gas is merely stopped, but the gas within the separator passage comes to rest. According to the consideration of the present inventors, a current is allowed to flow in the cell only for a very short period of time, in other words, oxygen is reduced by a very slight quantity of electricity, thereby making it possible to form a very small amount of produced water on the surface of the cathode catalyst (Pt fine particles). It is estimated that the produced water prevents the cathode catalyst surface from coming in direct contact with oxygen as a capsule, and the reaction of hydrogen is effectively suppressed. As a result, it is possible to effectively prevent the generation of hydrogen peroxide.

The cathode potential is decreased by a slight quantity of produced water, and a phenomenon that the cell voltage rapidly drops can be observed apparently. Finally, the cell voltage becomes substantially zero, and the current hardly flows.

In this embodiment, it has been confirmed that the current after the fuel cell stops becomes in a range of from 0 to 50 mV, and the range is maintained even after the fuel cell has been left overnight. When the above stopping method is applied, it is possible to suppress the oxygen reduction reaction on the cathode by the slight amount of produced water. Also, immediately after the fuel cell according to this embodiment stops, the great majority of oxygen remains in the separator passage without being reduced.

In this embodiment, the valve of the oxidant gas may be in the open state. This is because the gas in the cathode passage can come to rest. In other words, the rest of the oxidant gas in the present invention has a meaning completely different from the feed stop of the oxidant gas.

In this embodiment, it is necessary that the flow of the oxidant gas inside the cell stack comes to rest. As one means for realizing this operation, there is a method of closing a valve that is located upstream from the oxidant gas source and stopping the feeding of the oxidant gas. However, the method of the present invention is conceptually different from the mere stop of gas feeding in this method.

In order to clarify the above difference, the features of the present invention will be described assuming the following phenomenon. In order to stop the fuel cell, a valve, which is disposed on a piping system for feeding air to the cell stack from the blower at the time of electricity generation, is normally closed. As a result, the feeding of the oxidant gas to the cell stack stops. This is identical with the general gas feed stop. Then, in the general gas feed stop, another piping system for connecting the oxidant gas inlet and outlet of the cell stack via a pipe is used to circulate the oxidant gas by a pump. In this case, the flow of the oxidant gas cannot be stopped inside the cell stack, and the advantages of the present invention cannot be obtained. This is because when the air flows in the passage of the cathode separator, water produced on the cathode is blown off, the cathode catalyst is exposed, and the high open circuit voltage is returned. As a result, the cell deterioration is advanced. When the above gas circulation is conducted, oxygen in the oxidant gas is consumed with the elapse of an electricity generation time, which leads to a problem on the deterioration of the electrode catalyst.

As described above, since the effects of the present invention cannot be obtained by the conventional oxidant gas feed stop, the rest of the oxidant gas according to the present invention is clearly conceptually different from the mere feed stop of the oxidant gas. The above-mentioned case of describing the difference between the present invention and the conventional oxidant gas feed stop does not mean that the present invention doesn't adopt the oxidant gas feed stop. The present invention adopts the rest of the flow of the oxidant gas in addition to the oxidant gas feed stop. That is, the rest of the flow of the oxidant gas is of importance to the present invention.

In addition, since the present invention intends to consume little oxidant gas during stop of the fuel cell system, in such a view point, also viewing from such a perspective, the difference therebetween is clear.

The residual volume of oxygen immediately after the stop operation is conducted can be measured by feeding carrier gas such as helium or algorithm, which does not get involved in the reaction of the fuel cell, to the fuel cell, and actual-measuring oxygen in the gas which has been discharged from the fuel cell.

As a specific structural example of the fuel cell system according to this embodiment, there is a fuel cell system including a fuel processor for feeding the fuel gas to a stack, and a control unit for opening/closing control a feed valve for feeding the fuel gas or air to the fuel cell.

Another specific structural is provided by an electricity generation system with a controller for controlling a short cut controller. The short-cut controller is configured, at the time of stopping the fuel cell, to connect the short cut controller to the polymer electrolyte fuel cell before closing the feed valve and the discharge value for the hydrogen, and to take out an external current flowing in the short cut controller to thereby oxidize hydrogen in the fuel gas. Further, the following a fuel cell system is suggested. The fuel system has a control unit that closes a discharge valve for discharging the fuel gas or air from the fuel cell at the time of stopping the fuel cell.

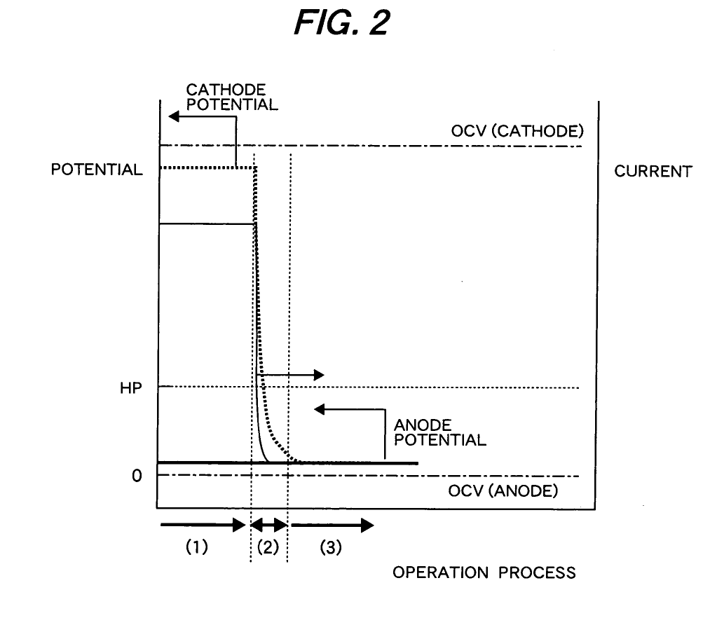

Hereinafter, a description will be given of the concept and features of the present invention for stopping the electricity generation (fuel cell) system as an embodiment. A first step of the stopping method according to this embodiment will be first described. When changing over to a stop mode of the electricity generation system, normally the electricity generation system has been in an electricity generation state before changing over to the stop mode. In this situation, in the potentials of the respective electrodes, as indicated by reference numeral (1) in FIG. 2, the anode is at the higher potential side than OCV (anode), the cathode is at the lower potential side than OCV (cathode), and a potential difference between those electrodes becomes a cell voltage. The “OCV” is the abbreviation of an open circuit voltage. The state of the cell stack in the first step may be a state in which an electric power is fed to the external (including an inverter and a converter).

In this case, the processing is shifted to a subsequent second step in a state where electricity is fed to the inverter or the converter (that is, in a state where the cell stack and the inverter are connected to each other on the circuit). In the case of the OCV state, a current is fed to the inverter or the converter from the stack, or flows in the short cut controller by a changeover switch. The processing is shifted to the second step from that state.

In the second step, an air flow rate under the normal electricity generation conditions is set to zero, to allow the air flow in the separator within the fuel cell to rest. Even if the air flow does not perfectly come to rest and an infinitesimal quantity of air flows, the air flow is allowed not to strictly rest as long as the generated water is not emitted from the cathode catalyst surface. In this way, it is possible to rapidly decrease the cathode potential. The present invention is characterized in that the flow of the oxidant gas comes to rest, and the current is allowed to flow. Therefore, it is possible that the operation in the second step is implemented first from the OCV state, after that the operation (first operation) of making the current flow is conducted.

Also, it is desirable that a period of time during which the cathode potential is dropped is as short as possible. Because hydrogen peroxide is produced as a partially reduced product of oxygen on condition of about 0.7 V or lower with reference to the anode potential of the open circuit. Therefore it is necessary to shorten a current-carrying time of up to completion of the fuel cell-stop operation. The hydrogen peroxide acts to decompose the electrolyte membrane, and therefore it is preferable that the quantity of hydrogen peroxide is as small as possible. For that reason, a period of time during which the potential is dropped is preferably 1 second or shorter, more preferably 0.1 seconds or shorter. It is desirable that the current concentration is equal to or more than 50 mA/cm² by the area standards of the membrane electrode assembly, and it is more desirable that the current concentration is in a range of from 200 to 500 mA/cm² from the viewpoint of avoiding the local heating.

In the fuel cell-stop operation, in addition to the above operation, when adopting the operation of stopping or decreasing the feed of the fuel gas before or during the above operation, the anode potential may be also increased. In this case, the regular upper limit cell potential is defined. For example, when using alloy catalyst including platinum and ruthenium, the regular upper limit cell potential is set to 0.4 V in order to prevent ruthenium from being solved. The feed quantity of fuel gas is controlled so that the cathode potential reaches the regular upper limit cell potential first. Since the anode potential does not exceed the above potential after the cathode potential has reached the regular upper limit cell potential first, it is possible to arbitrarily set the feed quantity of fuel gas.

In a third step, the feed of the fuel gas is stopped. This is realized by closing the fuel gas feed valve and the discharge valve which are disposed in front of and in the rear of the stack. The fuel gas to be fed until just before the valve closing operation is completed may contain hydrogen gas with a concentration required for the normal electricity generation, or with concentration lower than that at the time of normal electricity generation. The latter gas can be controlled by the feed quantity of raw gas of the fuel processor, and the temperature control. In this way, the fuel gas at the anode side is trapped within the cell stack, thereby making it possible to limit the quantity of hydrogen oxidation at the time of the fuel cell-stop operation, to prevent the hydrogen being left in the pipe from being leaked into the stack, and to rapidly complete the oxidation which removes hydrogen.

In a fourth step, the fuel cell is so sealed as to be shield against the outer air. So the valve of the air feed pipe or the discharge pipe is closed. As the occasion demands, a gas with a low hydrogen concentration or an inert gas is sent to the fuel cell at the anode side, and the hydrogen concentration is lowered to 0 or as much as possible, and the gas is stored.

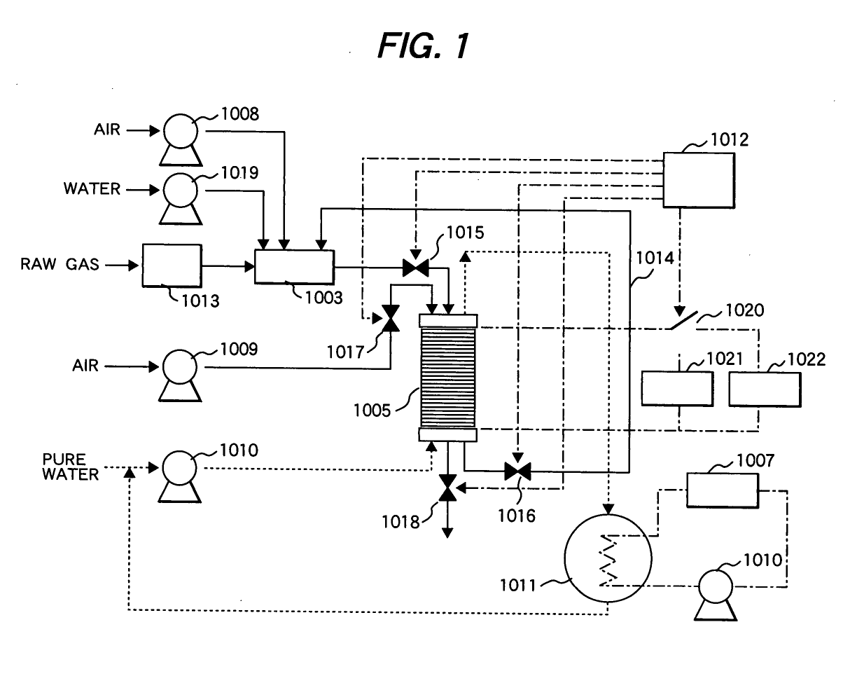

FIG. 1 is a structural diagram showing a fuel cell power generation system according to the present invention. Air is fed to a fuel processor 1003 by an air feed pump 1008 and water is fed to the fuel processor 1003 by a water feed pump 1019. Also, a raw gas is fed to the fuel processor 1003 through a prefilter. In addition, air is fed to a fuel cell stack by an oxidant gas pump, and pure water is fed to the fuel cell stack by a circulating water pump as in the conventional art.

The open/close operation of a changeover switch 1020 for a short cut controller, a fuel gas feed valve 1015, and an oxidant gas feed valve 1017 can be controlled by a controller 1012 with a computing function installed in the electricity generation system via signal cables. Operating conditions are memorized in the controller 1012 in advance, thereby making it possible to conduct the repeating operation. Also, a potential change of the anode and cathode due to age deterioration of the stack is estimated, and the valve open/close operation can be changed according to the operation time.

FIG. 2 shows a change in the potential with time when the method of stopping the fuel cell of this embodiment is implemented under the conditions where a flow of the oxidant gas comes to rest without stopping the feed of the fuel gas. FIG. 2 shows an example of a second step according to this embodiment, which is the simplest embodiment of the present invention. The cathode potential is rapidly decreased by a current flowing at the time of stop, and coincides with the anode potential at a potential lower than a regular upper limit cell potential(HP). In other words,the cell potential becomes zero at a point P.

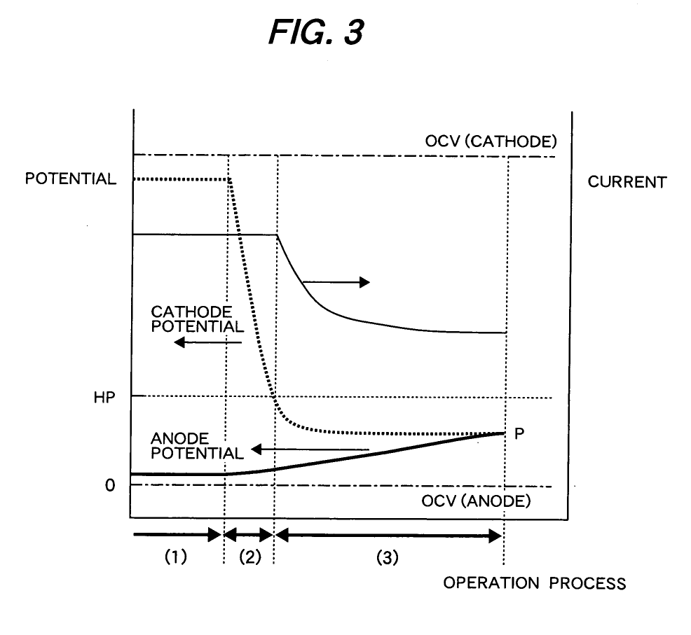

FIG. 3 shows a change in the potential with time when the feed of the fuel gas is stopped in the process of the stop operation, and the stopping method according to the present invention is implemented. In this case, the anode potential slightly increases, and the potentials of the anode and cathode coincide with each other at a potential that is lower than the regular upper limit cell potential (HP) whereby the electricity generation current does not flow. The point P is indicative of the potential at the time of completion.

In both cases of FIGS. 2 and 3, the processing is shifted to the above-mentioned third step after the cell voltage becomes zero. Then, a typical embodiment according to the present invention will be described with reference to those drawings. The present invention is not limited to the embodiments described below.

### First Embodiment

A fuel cell according to this embodiment has a single cell as the basic cell, and normally has a function of outputting a DC electric power by multilayered cells, for example, several tens cells or more. In this embodiment, the fuel cell is made up of 80 cells. The single cell is made up of a membrane electrode assembly provided with electrode layers on both sides of a solid polymer electrolyte membrane, and two separators. The separators hold the membrane electrode assembly therebetween, and a gasket is inserted between those separators. A channel in which the fuel gas is circulated is formed in one of those separators. A channel in which the oxidant gas, normally air is circulated is formed in the other separator. Those cells are stacked, and a positive current collector and a negative current collector are disposed on a terminal. The stacked cells are pressurized by end plates from the outer sides of the current collectors through insulation plates. Parts that fix the end plates are made up of bolts, springs, and nuts. The fuel gas, the oxidant gas, and the coolant are fed from a connector that is disposed in the end plate and discharged from a connector that is disposed in the other end plate. A DC electric power (output) can be obtained by the positive current collector and the negative current collector.

The stopping method according to this embodiment is conducted by the changeover switch and the short cut controller on a load cable which is connected to the current collectors of the stack. At the time of normal electricity generation, the switch is connected to the inverter or converter side, and the DC electric power is supplied to the inverter or the converter from the stack. When the stop mode is executed, the switch is changed over to the short cut controller, thereby the current from the fuel cell can flow through the short-cut controller as an external short-cut current.

In this embodiment, the stopping method using the exclusive short cut controller will be described. However, it is possible to allow the inverter or the converter to double as the short cut controller. In this case, it is necessary to set the lower limit voltage setting value of the inverter to be lower than HP.

FIG. 1 is a structural diagram showing a polymer electrolyte fuel cell system according to this embodiment. A reformed gas is used with a town gas as a raw gas, and then fed to the fuel processor 1003 through the prefilter 1013. Air and water required for production of the reformed gas are fed by the pumps. The concentration of hydrogen contained in the reformed gas is 70% (dry base). The fuel gas to be fed to the stack is produced in the fuel processor, and then fed from a feed pipe having a fuel gas feed valve.

The oxidant gas is fed to the stack through a pipe having the oxidant gas feed valve 1017 by driving an air feed pump (blower) 1009. After electricity generation in the stack, the fuel gas is returned to the fuel processor 1003 through a pipe with a fuel gas discharge valve 1016, and then used for heat retention for a reforming catalyst. The oxidant gas is discharged to the atmosphere from a pipe with an oxidant gas discharge valve 1018. In order to remove a heat from the stack and recover the heat, pure water is fed to the stack by a circulating water pump 1010. The water is circulated from the stack to the stack by the circulating water pump 1010, and heat of the water is transferred to water being reserved in a hot water reservoir tank 1007 via a heat exchanger on the way of the water circulation. The water in the hot water reservoir tank is circulated by another circulating water pump 1010.

The fuel gas feed valve 1015, the fuel gas discharge valve 1016, the oxidant gas feed valve 1017, and the oxidant gas discharge valve 1018 is controlled by the controller 1012. Since the fuel gas from the fuel gas discharge valve 1016 contains unburned hydrogen gas, the gas is returned to the fuel processor through a fuel gas return pipe 1014.

When shifting from a rated electricity generation state of the stack to the stop operation mode thereof, the following stop operation of the stack is implemented. First, the changeover switch 1020 for short-cut control is connected to the short-cut controller 1021 side by an instruction issued from the controller 1012, thereby a current flowing in the inverter 1022 becomes zero. Then, the cathode feed valve 1017 is closed to cut off the feed of air to the stacked body 1005 of the fuel cell. The same effect is obtained by another method in which a stop signal is outputted from the controller 1012 to stop the blower 1009.

For example, the short-cut controller 1021 is comprises a resistor circuit, and the resistor circuit can sufficiently functions by itself only as short-cut controller. As the occasion demands, the short-cut controller 1021 may comprises a variable resistor. Alternatively, it is possible to omit the exclusive short-cut controller and to double the inverter 1022 as the short-cut controller. In this case, the electric power at the time of the stop operation is fed directly to the inverter 1022. The inverter 1022 can be replaced with a converter.

Those sequential automatic operations of the valves, the blower, the short-cut controller, and the changeover switch is executed by the controller 1012. The short-circuit current is set to 200 mA/cm² per unit area of the membrane electrode assembly.

During stop of the cell stack, the feed of the fuel gas is stopped. That is, after confirming that the cell voltage became zero, the feed of the fuel gas is made stop. Thereafter, the circulation of the coolant is stopped, then the fuel cell is cooled naturally. After about 5 hours have been elapsed, the cell temperature becomes 30° C. or lower, and an average cell voltage at that time is 14 mV.

After confirming that the cell temperature becomes 30° C., the fuel cell electricity generation system is started, the electricity generation test is conducted under the rated condition, and the operation at the stop mode is conducted under the same condition. The start-stop operation is repeated by 100 times, the resulting output voltage of the stack to be inputted to the inverter 1022 is 59.8 to 59.9 V with respect to an initial voltage 50 V, under the rated condition.

As a result of measuring the oxygen concentration in the interior of the cell by gas chromatography, immediately after the stopping operation is conducted according to this embodiment, it is found that the oxygen concentration is 18%. A precision of this analysis is ±1%. It is found from this result that oxygen in the air is not almost consumed.

### Second Embodiment

In this embodiment, A short-circuit current is allowed to flow in the external in a state where the fuel gas feed valve 1015 and the oxidant gas feed valve 1017 are closed at the same time. A change in the voltage with time in the situation is shown in FIG. 3. Similarly, in this case, the regular upper limit cell potential (HP) is set to 0.4 V, and the potential P when the cell voltage becomes zero becomes 0.2 o 0.3 V.

Other operation is identical with that in the first embodiment, and the cell stopping operation is completed. After it is confirmed that the cell temperature becomes 30° C. or lower, the fuel cell electricity generation system starts, the electricity generation test is conducted under the rated condition, and the operation at the stop mode is conducted under the same condition. The start-stop operation is repeated by 100 times, the resulting output voltage of the stack to be inputted to the inverter 1022 is 59.7 to 59.9 V with respect to an initial voltage 50 V, under the rated condition. This result is substantially the same as that in the first embodiment.

What is claimed is:

1. A fuel cell system comprising:
an electrolyte membrane having an ion conductivity,
a pair of electrodes contacting with the electrolyte membrane, and
a separator having at least a passage for an oxidant gas,
a device for setting a cell voltage to substantially zero at the time of an stop operation of the fuel cell by setting a flow rate of the oxidant gas in the passage to substantially zero in a state of taking out a current from the cell.

2. The fuel cell system according to claim 1, wherein the fuel cell has an output terminal for taking out an output to the external; the device comprises a short-cut controller connected to the output terminal; and the short cut controller is configured to control a current from the fuel cell and the feed quantity of a fuel gas to be fed to the fuel cell, so as to set a cathode potential to a regular upper limit cell potential or lower before an anode potential reaches the regular upper limit cell potential.

3. The fuel cell system according to claim 1, wherein the device is configured to, after the cell voltage becomes substantially zero, pass a gas with a hydrogen concentration lower than that at the time of electricity generation, or an inert gas through an anode electrode, and close the feed valve for a fuel gas.

4. The fuel cell system according to claim 1, wherein, when the fuel cell is in storage, the fuel cell in a state where the respective feed valves or discharge valves for the fuel gas and the oxidant gas are closed.

5. A polymer electrolyte fuel cell-electricity generation system, comprising:
an inverter or converter connected to the fuel cell via a cable,
a short-cut controller for forming a short-cut, and
a changeover switch provided on the way of the cable to select a connection of the inverter or converter and the fuel cell, or a connection of the short-circuit and the fuel cell,
wherein the short-cut controller is configured to control the cell voltage to be substantially zero by making a current flow in the fuel cell for a short period of time in a state where a flow rate of an oxidant gas in a passage of a separator of the fuel cell is set to substantially zero.
